(19) United States
(12) Patent Application Publication
(10) Pub. No.: US 2009/0024393 A1
(43) Pub. Date: Jan. 22, 2009

(54) Speech synthesizer and speech synthesis system

(75) Inventor: Tsutomu Kaneyasu, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/155,913

(22) Filed: Jun. 11, 2008

(30) Foreign Application Priority Data
Jul. 20, 2007 (JP) 2007-189988

(51) Int. Cl. G10L 13/00; G10L 13/08; G10L 13/06

(52) U.S. Cl. 704/260; 704/268; 704/E13.001; 704/E13.002

(57) ABSTRACT

A speech synthesizer conducts a dialogue among a plurality of synthesized speakers, including a self speaker and one or more partner speakers, by use of a voice profile table describing emotional characteristics of synthesized voices, a speaker database storing feature data for different types of speakers and/or different speaking tones, a speech synthesis engine that synthesizes speech from input text according to feature data fitting the voice profile assigned to each synthesized speaker, and a profile manager that updates the voice profiles according to the content of the spoken text. The voice profiles of partner speakers are initially derived from the voice profile of the self speaker. A synthesized dialogue can be set up simply by selecting the voice profile of the self speaker.

### BACKGROUND OF THE INVENTION

1. Field of the Invention

The present invention relates to a speech synthesizer and a speech synthesis system, more particularly to a system with a plurality of interacting speech synthesizers.

2. Description of the Related Art

Speech synthesis from an input text is a known art that has long been used to enable computers to engage in dialogues with human beings. Now that people are creating virtual worlds populated by various types of software agents and avatars, for purposes ranging from serious business to pure entertainment, there is also a need for software entities to interact with each other by synthesized speech.

When a dialogue is conducted through synthesized speech, the speech should be uttered in tones appropriate for the content of the dialogue and the characteristics of the speakers. Japanese Patent Application Publication No. 08-335096 discloses a text-to-speech synthesizer with a table of phoneme durations appropriate for various speaking styles, which are selected according to the phonemic environment and other such parameters derived from the text to be spoken. This produces a more natural speaking style, but the synthesizer is not intended for use in a dialogue among synthesized speakers and fails to adapt its speaking voice to the characteristics of the party being spoken to.

Japanese Patent Application Publication No. 2006-071936 discloses a dialogue agent that infers the user's state of mind from the user's facial expression, speaking tone, and cadence, generates suitable reply text, and synthesizes speech from the generated text, but this agent does not adapt its synthesized speaking voice to the user's inferred state of mind.

### SUMMARY OF THE INVENTION

An object of the present invention is to provide a speech synthesizer that automatically assigns suitable speaking characteristics to synthesized speakers participating in a dialogue.

The inventive synthesizer has a word dictionary storing information indicating characteristics of words, a voice profile table storing information indicating characteristics of one or more synthesized voices, and a speaker database storing feature data for different types of speakers and/or different speaking tones. A text analyzer receives and analyzes an input text to be spoken by one of the synthesized speakers. A speech synthesis engine refers to the speaker profile to obtain the characteristics of this synthesized speaker, searches the speaker database to find feature data fitting these characteristics, and synthesizes speech from the input text according to the feature data.

One of the synthesized speakers in the dialogue is designated as a self speaker. The other synthesized speakers are designated as partner speakers. A voice profile is assigned to each of the synthesized speakers. The partner speakers' voice profiles are initially derived from the self speaker's voice profile, and may be initially identical to the self speaker's voice profile. The self speaker's and partner speakers' voice profiles are preferably updated during the dialogue according to the content of the input text.

One or more of these speech synthesizers may be used to implement a virtual spoken dialogue among human users and/or software entities. The dialogue is easy to set up because a human user only has to select the synthesized voice of the self speaker. Since each partner speaker's synthesized voice characteristics are initially derived from the self speaker's characteristics, the partner speakers address the self speaker in a suitable style.

### BRIEF DESCRIPTION OF THE DRAWINGS

In the attached drawings:

FIG. 1 is a functional block diagram of a speech synthesizer embodying the invention;

FIG. 2 is a table showing the structure of the word dictionary in FIG. 1 and exemplary data;

FIG. 3 is a table showing the structure of the voice profile table in FIG. 1 and exemplary data; and

FIG. 4 illustrates an exemplary speech synthesis system embodying the invention.

### DETAILED DESCRIPTION OF THE INVENTION

Embodiments of the invention will now be described with reference to the attached drawings, in which like elements are indicated by like reference characters.

### First Embodiment

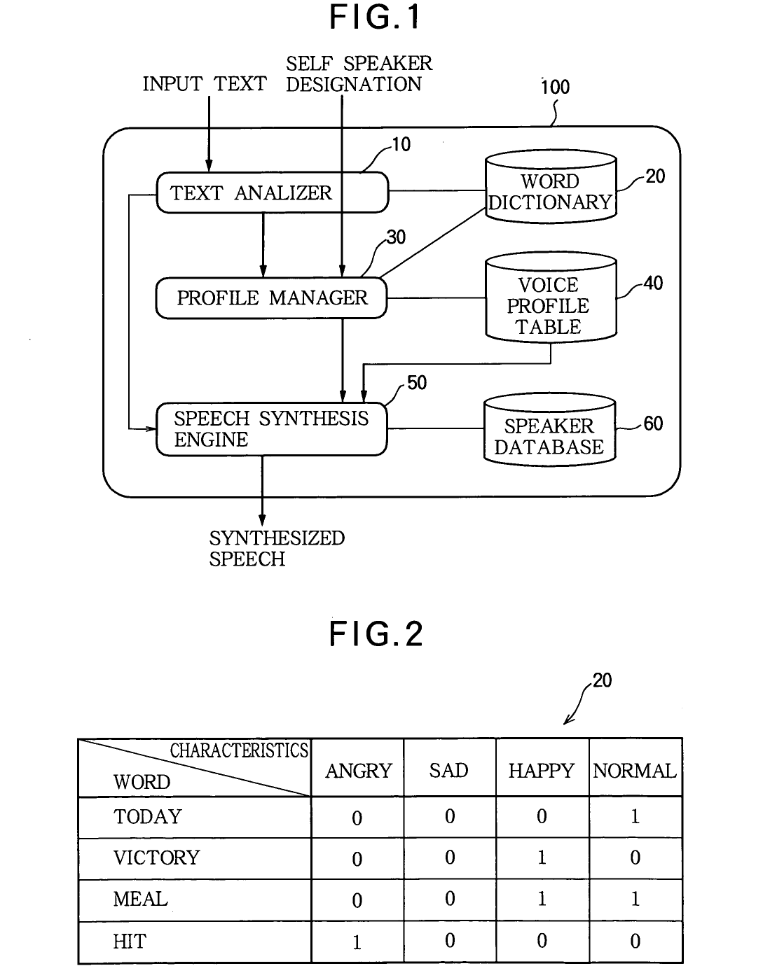

Referring to FIG. 1, the speech synthesizer 100 comprises a text analyzer 10, a word dictionary 20, a profile manager 30, a voice profile table 40, a speech synthesis engine 50, and a speaker database 60.

The text analyzer 10 receives an input text to be spoken by one of the synthesized speakers and extracts words from the input text. If necessary, the text analyzer 10 performs a morphemic analysis and a dependency analysis of the input text for this purpose. The input text and the results of the analysis are output to the speech synthesis engine 50, and the extracted words are output to the profile manager 30.

The word dictionary 20 stores data indicating emotional characteristics of words.

The profile manager 30 receives the words extracted from the input text by the text analyzer 10, a self speaker designation, and a tone designation, uses the word characteristic data stored in the word dictionary 20 to update the information stored in the voice profile table 40, and outputs the self speaker designation and tone designation to the speech synthesis engine 50. This process will be described in more detail later.

The speech synthesis engine 50 synthesizes speech from the output of the text analyzer 10 by using the data stored in the voice profile table 40 and speaker database 60 as described in more detail later.

The speaker database 60 stores feature data for a plurality of speakers and speaking tones.

The text analyzer 10, profile manager 30, and speech synthesis engine 50 may be implemented in hardware circuits that carry out the above functions, or in software running on a computing device such as a microprocessor or the central processing unit (CPU) of a microcomputer.

The text analyzer 10 has a suitable interface for receiving the input text. The speech synthesis engine 50 has a suitable interface for output of synthesized speech, either as speech data or as a speaking voice output from a speaker.

The word dictionary 20, voice profile table 40, and speaker database 60 comprise areas in a memory device such as a hard disk drive (HDD) for storing the word data and speaker characteristic data.

Referring to FIG. 2, the word dictionary 20 stores data associating words with speaker characteristics. In the association scheme illustrated in FIG. 2, the value ‘1’ indicates that the items in the corresponding row and column are related, and the value ‘0’ indicates that the items in the corresponding row and column are not related.

In the exemplary data in FIG. 2, the word ‘victory’ and the speaker characteristic ‘happy’ are related. This means that a synthesized speaker that utters the word ‘victory’ should sound happy. Similarly, a synthesized speaker that utters the word ‘hit’ should sound angry.

A word may be related with a plurality of speaker characteristics. In the exemplary data in the third row in FIG. 2, the word ‘meal’ is related with the speaker characteristics ‘happy’ and ‘normal’.

From the characteristics related to the words extracted from an input text spoken by a partner speaker, the profile manager 30 can characterize the partner speaker. The process after the partner speaker has been characterized will be described below.

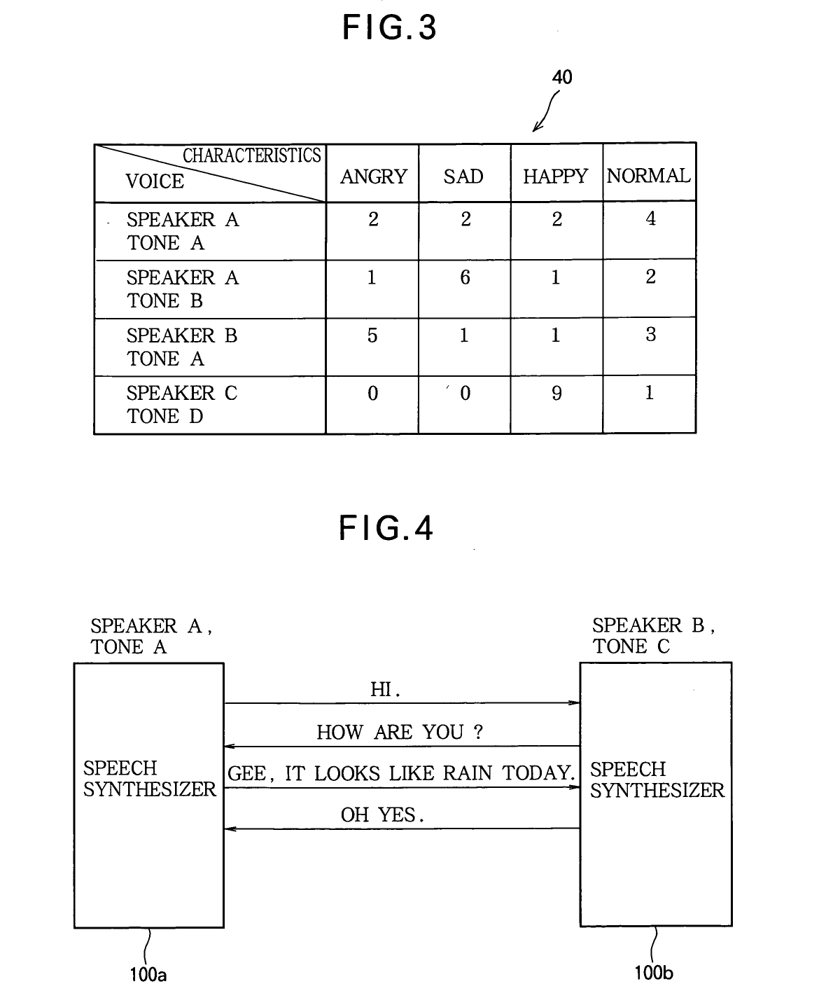

Referring to FIG. 3, the voice profile table 40 stores data characterizing a list of synthesized voices, which in the present example are identified as the voice of a particular speaker speaking in a particular tone. The numerical values shown as exemplary data in FIG. 3 represent multiples of ten percent. The user can select one listed speaker and tone as a self speaker.

From the exemplary data in FIG. 3, if speaker A and tone A are selected as the self speaker, the data indicate a speaking voice that is 20% angry, 20% sad, 20% happy, and 40% normal (the value ‘2’ means 20% and ‘4’ means 40%). In a synthesized dialogue, these characteristics of the self speaker are also used as the initial characteristics of each partner speaker.

Similarly, if speaker C and tone D are selected as the self speaker, the data indicate that the self speaker and, initially, each partner speaker will speak in a voice that is 90% happy and 10% normal, with no anger or sadness.

When a self speaker is designated, the speech synthesis engine 50 refers to the data in the voice profile table 40 to obtain the initial synthesized voice characteristics of each partner speaker from the characteristics of the self speaker, and searches the speaker database 60 to find feature data fitting the partner speaker's characteristics.

The reason for deriving the characteristics of a partner speaker from the characteristics of the self speaker is as follows.

When self speaker C and tone D are designated, for example, the data in the fourth row in FIG. 3 indicate that the self speaker will be speaking in a tone with a high level of the emotional characteristic ‘happy’, so the input text spoken by the self speaker will sound happy.

In a dialogue among human beings, unlike a dialogue among conventional synthesized speakers, happiness is infectious. If a person speaks in a happy tone of voice, human partners will tend to respond in a happy tone of voice. Similarly, if a person speaks in an angry, sad, or normal tone of voice, a human partner will tend to adopt a similarly angry, sad, or normal tone of voice.

Therefore, if the synthesized speaking voice and tone of a partner speaker are initially set to match the synthesized speaking voice and tone of the self speaker, the partner speaker will seem to be responding to the self speaker in a natural way, with correct emotional content.

Although in real life human partner speakers are complex entities with their own characteristics, setting those characteristics in a speech synthesizer would entail a certain amount of time and trouble. It is simpler to use preset data such as the data in FIG. 3, and starting the synthesized partner speakers out with the same preset speaking voices as the synthesized self speaker results in a natural-sounding conversation with appropriate emotional voice characteristics.

Next, the updating of the data stored in the voice profile table 40 will be described.

In the description above, the synthesized speaking voice of a partner speaker are initially set to match the synthesized speaking voice of the self speaker, but the synthesized speaking voices of the self speaker and partner speaker need not match throughout the dialogue; they should vary according to the content of the input text spoken by each speaker.

Even if the self speaker speaks mainly in a happy tone of voice, for example, depending on the content of the dialogue, a partner speaker's reply may include a sad piece of information. For the partner speaker to utter this information in a happy tone of voice would seem unnatural.

Accordingly, although each partner speaker starts out with preset speaking characteristics selected from the voice profile table 40, described by numerical values as in FIG. 3, these numerical values should be updated according to the content of each spoken text, before the text is spoken. Successive updates allow the tone of the dialogue to vary from the selected initial characteristics to characteristics adapted to what is currently being said.

Next, the operation of the speech synthesizer in the first embodiment will be described below with reference to FIGS. 1 to 3, assuming that the synthesized dialogue is conducted between the self speaker and one partner speaker. The procedure for starting a dialogue in which the partner speaker speaks first is as follows.

(1) Designate Self Speaker and Tone

A self speaker and a tone are designated and input to the profile manager 30. In this example, speaker A and tone B are designated. The partner speaker and tone are not specified yet.

(2) Input Text Spoken by Partner Speaker

The text analyzer 10 receives an input text to be spoken by the partner speaker. The input text may comprise, for example, one or more sentences. In a language such as Japanese that does not mark word boundaries, the boundaries between individual words may be unclear.

(3) Analyze Input Text

The text analyzer 10 extracts the individual words from the input text. For a language such as Japanese, this may require a morphemic analysis and a dependency analysis of the input text. The input text and the results of the analysis are output to the speech synthesis engine 50, and the extracted words are output to the profile manager 30.

(4) Characterize Partner Speaker

The profile manager 30 receives the words extracted from the input text spoken by the partner speaker by the text analyzer 10, and uses the word characteristic data stored in the word dictionary 20 to characterize the partner speaker according to the content of the input text.

Suppose, for example, that the words extracted from the input text includes forty-five words characterized as ‘angry’, one word characterized as ‘sad’, one hundred words characterized as ‘happy’, and thirty words characterized as ‘normal’ out of a total of 176 words (45+1+100+30=176) to be spoken by the partner speaker. These data indicate that the partner speaker's speaking voice should be 26% angry, 1% sad, 57% happy, and 17% normal.

The data in the voice profile table 40 indicate speaker characteristics with a string of numbers on a standard scale graded in multiples of ten percent. The profile manager 30 adjusts the speaker characteristics to this scale by dividing the above percentages by ten and ignoring fractions, obtaining a string of numbers (2, 0, 5, 1) indicating a speaking voice that is 20% angry, 0% sad, 50% happy, and 10% normal.

(5) Update Partner Speaker Profile

The numbers (2, 0, 5, 1) indicating percentage data (20% angry, 0% sad, 50% happy, and 10% normal) obtained in step (4) are now normalized by adding a value x that makes the numbers sum to zero, so that they will not change the total value of a row in the voice profile table 40. The profile manager 30 then uses the normalized string of numbers as an adjustment string to update the data stored in the voice profile table 40.

Since there are four speaker characteristics (‘angry’, ‘sad’, ‘happy’, and ‘normal’) to be updated, the value of x is obtained from equations below.

2+0+5+1+4x=0

x=−2

Adding the value of x (−2) obtained from this equation to the numbers (2, 0, 5, 1) in the string yields an adjustment string of numbers (0, −2, 3, −1) indicating the partner speaker's voice should be adjusted to sound less sad, more happy, and less normal (0% angry, −20% sad, +30% happy, −10% normal). The profile manager 30 adds the numbers in the adjustment string to the numbers stored in the second row for the items of the voice characteristics of speaker A with tone B in FIG. 3 to update the voice profile table 40. After the updating process, the adjusted numbers (1, 4, 4, 1) in the string in the second row in FIG. 3 indicate a voice that is 10% angry, 40% sad, 40% happy, and 10% normal. Because of the normalizing process described above, the updated numbers in the second row in FIG. 3 still sum to ten (100%).

If the value x is not an integer, it may be rounded up when added to some of the numbers in the string and rounded down when added to other numbers, to make the adjustment string sum to zero.

(6) Execute Speech Synthesis

The speech synthesis engine 50 receives the self speaker designation and the tone designation (speaker A and tone B) from the profile manager 30, and reads the adjusted data (1, 4, 4, 1) indicating the updated characteristics of the designated speaker and tone from the voice profile table 40.

Next, the speech synthesis engine 50 uses the adjusted data (1, 4, 4, 1) read from the voice profile table 40 as search conditions, and searches the speaker database 60 to find feature data fitting the adjusted characteristics of the partner speaker. Because the speech synthesis engine 50 synthesizes speech by using the feature data stored in the speaker database 60, the synthesized speech of the partner speaker has vocal characteristics derived from the characteristics of the self speaker by adjusting these characteristics according to the content of the spoken text.

The reason for normalizing the adjustment string so that its numbers sum to zero in steps (4) and (5) is to keep the partner speaker's voice characteristics from becoming emotionally overloaded. If the characteristic values obtained from the input text were to be added to the data in the voice profile table 40 without normalization (x=0), the updated values would tend to increase steadily, eventually exceeding the scale of values used in the speaker database 60. It would then become difficult or impossible to find matching feature data in the speaker database 60 in step (6).

As described above, according to the first embodiment, since each partner speaker is initially assumed to have speaking characteristics matching the characteristics of the self speaker, and these characteristics are then adjusted according to the spoken text, the dialogue conducted between the synthesized speakers sounds natural. Moreover, this result is achieved without the need for extensive preparations; it is only necessary to designate one of the preset voice profiles as belonging to the self speaker.

When the profile manager 30 updates the data stored in the voice profile table 40, the updated data are retained in the voice profile table 40. The data are also be updated when the self speaker speaks. The dialogue thus develops in a natural way, the voice characteristics of each synthesized speaker changing according to changes in the other synthesized speakers' voice characteristics, and also changing according to the characteristics of the words spoken by the synthesized speaker.

In a variation of the first embodiment, the voice profile table includes only one voice profile. The initial characteristics of this voice profile can be selected by, for example, activating a button marked ‘normal’, ‘happy’, ‘sad’, or ‘angry’, or by using slide bars to designate different degrees of these characteristics.

In another variation of the first embodiment, each synthesized speaker is assigned a separate voice profile. The voice profiles of the partner speakers are initialized to the same values as the voice profile selected for the self speaker, but each voice profile is updated separately thereafter. The speaking voice of each synthesized speaker then changes in reaction only to the characteristics of the words spoken by that synthesized speaker. Since all participating speakers start out with the same voice characteristics, however, the dialogue begins from a common emotional base and develops naturally from that base.

In a variation of this variation, only the partner speakers' voice profiles are updated automatically. The self speaker's voice profile may be updated manually, or may remain constant throughout the dialogue.

In yet another variation, instead of assigning the same initial voice characteristics to each synthesized speaker, the speech synthesizer gives the partner speakers characteristics that complement the characteristics of the self speaker. For example, if an angry initial voice profile is selected for the self speaker, the partner speakers may be assigned an initially sad voice profile.

In still another variation, each synthesized speaker has a predetermined speaker identity with various selectable speaking tones. When a speaking tone is designated for the self speaker, corresponding or complementary tones are automatically selected for each partner speaker. The voice profile table in this case may include, for each partner speaker, data indicating the particular initial voice profile the partner speaker will adopt in response to each of the speaking tones that may be selected for the self speaker.

### Second Embodiment

In the first embodiment, a plurality of synthesized speakers conducted a dialogue within a single speech synthesizer. In the second embodiment, a dialogue is carried out among a plurality of speech synthesizers.

Referring to FIG. 4, a speech synthesizer 100a and a speech synthesizer 100b, each similar to the speech synthesizer described in the first embodiment, conduct a dialogue by sending input text to each other and synthesizing speech from the sent and received texts. In this example, speech synthesizer 100a represents the self speaker in the first embodiment, and speech synthesizer 100b represents the partner speaker.

A synthesized voice profile is assigned to the self speaker in speech synthesizer 100a. For example, speaker A and tone A in FIG. 3 may be designated as the self speaker.

Speech synthesizer 100a has an interface for receiving the input text to be spoken by the partner speaker from speech synthesizer 100b. Alternatively, a prestored script may be used.

Speech synthesizer 100a uses the designated self speaker characteristics (e.g., speaker A, tone A) and the characteristics of the partner speaker's input text to determine the characteristics of the partner speaker by one of the methods described in the first embodiment and its variations. In the following description it will be assumed that the partner speaker has a predetermined identity (e.g., speaker B) and it is only the partner speaker's tone of voice that has to be determined (e.g., tone C). Speech synthesizer 100a sends the characteristics thus determined (e.g., speaker B, tone C) to speech synthesizer 100b.

Speech synthesizer 100b synthesizes and outputs the speech spoken by the partner speaker, initially using the characteristics (e.g., speaker B, tone C) designated by speech synthesizer 100a. As the dialogue progresses, both speech synthesizers 100a, 100b modify their synthesized speaking voices by updating their voice profile tables 40 as described in the first embodiment.

In the exemplary dialogue shown in FIG. 4, speech synthesizer 100a opens the dialogue by saying ‘Hi’ in, for example, a normal tone of synthesized voice. Speech synthesizer 100b replies ‘How are you?’ in a normal tone of synthesized voice. Speech synthesizer 100a speaks the next line, ‘Gee, it looks like rain today’ in a tone saddened by the occurrence of the word ‘rain’. Speech synthesizer 100b replies ‘Oh yes’ in a normal tone, the sadness of the word ‘rain’ being offset by the happiness of the word ‘yes’. The dialogue continues in this way.

The second embodiment provides the same effects of automatic adaptation and simplified setup as the first embodiment.

In the second embodiment as described above, speech synthesizer 100a designates the initial characteristics of both synthesized speakers, as may be desirable when speech synthesizer 100a represents a human user and speech synthesizer 100b represents a robotic software entity.

In a variation of the second embodiment, suitable when both speech synthesizers 100a, 100b represent human users, initial self speaker characteristics are designated independently at both speech synthesizer 100a and speech synthesizer 100b, after which both speech synthesizers 100a, 100b modify their synthesized speaking voices-by updating their voice profile tables 40. In this case the dialogue may be heard differently at different speech synthesizers.

In the second embodiment as described above, each speech synthesizer takes the part of one speaker in the dialogue, synthesizes the speech of that speaker, and sends the synthesized speech data, as well as the text from which the speech was synthesized, to the other speech synthesizer. The other speech synthesizer reproduces the synthesized speech data without having to synthesize the data. The same synthesized speech can thus be heard by human users operating both speech synthesizers. In this case, each speech synthesizer synthesizes speech only from the input text that it sends to the other speech synthesizer.

In another variation of the second embodiment, each speech synthesizer synthesizes speech from both the sent and received text. In this case as well, at each speech synthesizer, both parties in the dialogue are heard to speak in synthesized speech without the need to send synthesized speech data from one speech synthesizer to the other.

In yet another variation, each speech synthesizer synthesizes speech only from text it receives from the other speech synthesizer. In this case, a human user enters the text silently, but hears the other party reply in a synthesized voice.

To accommodate these variations, speech synthesizer 100a may send speech synthesizer 100b the self speaker's voice characteristics in addition to, or instead of, the partner speaker's voice characteristics.

In the preceding embodiments, speaker characteristic data were stored in the voice profile table on a standard scale of integers summing to ten, but in general, the standard scale is not limited to an integer scale and the sum is not limited to ten. The scale may be selected to fit the data stored in the speaker database.

The first and second embodiments are not restricted to two synthesized speakers conducting a dialogue as in the descriptions above. The number of synthesized speakers may be greater than two.

Those skilled in the art will recognize that further variations are possible within the scope of the invention, which is defined in the appended claims.

What is claimed is:

1. A speech synthesizer for conducting a dialogue among a plurality of synthesized speakers, comprising:
a word dictionary storing information indicating characteristics of words;
a voice profile table storing at least one voice profile including information indicating characteristics of a synthesized voice, each of the plurality of synthesized speakers being assigned a voice profile stored in the voice profile table;
a text analyzer for receiving an input text to be spoken by one of the synthesized speakers and extracting words from the input text;
a speaker database storing feature data for different types of speakers and/or different speaking tones; and
a speech synthesis engine for referring to the voice profile table to obtain the voice profile of said one of the synthesized speakers, searching the speaker database to find feature data fitting the voice profile of said one of the synthesized speakers, and synthesizing speech from the input text according to the feature data found in the speaker database; wherein
one of the plurality of synthesized speakers is designated as a self speaker, each other one of the plurality of synthesized speakers is designated as a partner speaker, and the voice profile assigned to each partner speaker is initially derived from the voice profile assigned to the self speaker.

2. The speech synthesizer of claim 1, further comprising a profile manager for using the word dictionary and the words extracted by the text analyzer to update the voice profile assigned to said one of the synthesized speakers in the voice profile table automatically before the speech synthesis engine refers to the voice profile table to obtain the voice profile assigned to said one of the synthesized speakers.

3. The speech synthesizer of claim 2, wherein:
the voice profile table stores the information indicating the characteristics of the synthesized voice assigned to said one of the synthesized speakers as a first string of numbers expressing relative strengths of different characteristics; and
the profile manager uses the word dictionary and the words extracted by the text analyzer to obtain a second string of numbers summing to zero, and updates the voice profile table by adding the numbers in the second string to the numbers in the first string.

4. The speech synthesizer of claim 1, wherein the characteristics indicated by the information stored in the word dictionary and voice profile table are emotional characteristics.

5. The speech synthesizer of claim 4, wherein the emotional characteristics include ‘normal’, ‘happy’, ‘sad’, and ‘angry’.

6. The speech synthesizer of claim 1, wherein the voice profile assigned to each partner speaker is initially identical to the voice profile assigned to the self speaker.

7. The speech synthesizer of claim 1, wherein the same voice profile is assigned to all of the plurality of synthesized speakers.

8. The speech synthesizer of claim 1, wherein the text analyzer extracts said words from the input text by performing a morphemic analysis of the input text.

9. A speech synthesis system including a plurality of speech synthesizers as recited in claim 1, wherein the plurality of speech synthesizers conduct the dialogue by sending input text to each other and synthesizing speech from the input text.

10. The speech synthesis system of claim 9, wherein:
the self speaker and at least one partner speaker are assigned a voice profile stored in the voice profile table at a first one of the speech synthesizers;
the first one of the speech synthesizers sends at least one of the assigned voice profiles to a second one of the speech synthesizers; and
the second one of the speech synthesizers synthesizes speech according to the at least one of the assigned voice profiles sent by the first one of the speech synthesizers.

11. The speech synthesis system of claim 10, wherein the first one of the speech synthesizers sends the voice profile assigned to the self speaker to the second one of the speech synthesizers.

12. The speech synthesis system of claim 10, wherein the first one of the speech synthesizers sends the voice profile assigned to the at least one partner speaker to the second one of the speech synthesizers.

13. The speech synthesis system of claim 10, wherein the first one of the speech synthesizers sends the voice profile assigned to the self speaker and the voice profile assigned to the at least one partner speaker to the second one of the speech synthesizers.

14. The speech synthesis system of claim 9, wherein a self speaker is designated independently at each one of the speech synthesizers, and voice profiles are assigned to the self speaker and each partner speaker independently at each one of the speech synthesizers.

15. The speech synthesis system of claim 9, wherein each one of the plurality of speech synthesizers synthesizes speech from the input text sent to another one or more of the plurality of speech synthesizers, and sends the synthesized speech to said another or more one of the plurality of speech synthesizers.

16. The speech synthesis system of claim 9, wherein each one of the plurality of speech synthesizers synthesizes speech from the input text received from another one or more of the plurality of speech synthesizers.

17. The speech synthesis system of claim 9, wherein each one of the plurality of speech synthesizers synthesizes speech from both the input text sent to and the input text received from another one or more of the plurality of speech synthesizers.
